(19) United States
(12) Patent Application Publication
(10) Pub. No.: US 2005/0108400 A1
(43) Pub. Date: May 19, 2005

(54) Optoacoustic operator's guide for mobile radio telephones

(76) Inventor: Clemens Kujawski, Munchen (DE)

Correspondence Address: BELL, BOYD & LLOYD, LLC, P. O. BOX 1135, CHICAGO, IL, 60690-1135, US

(21) Appl. No.: 10/500,488

(22) PCT Filed: Dec. 3, 2002
(86) PCT No.: PCT/DE02/04430

(30) Foreign Application Priority Data
Dec. 27, 2001 (DE) 101 64 206.7

(51) Int. Cl. H04L 9/00

(52) U.S. Cl. 709/227; 713/168; 709/246; 370/310

(57) ABSTRACT

The disclosure relates to a method for outputting help information in a mobile radio device, in which items of context relevant help information pertaining to operating functions and/or input functions are stored. The disclosure provides that, after a request, the help information is output by acoustic output and one or more signaling buttons.

### BACKGROUND

The present disclosure relates to the output of help information on a mobile radio device.

Modern mobile telephones or cell phones offer an increasing number of functions to a user for the operation of the device itself and for the input of, for example, SMS (short message service) messages or for calling up Internet content. To support the user, help text or information text can be called up, which is then displayed on the display device of the mobile telephone. A disadvantage of this is that help may also be provided for the information shown on the display. This means that while the help text is being displayed the user cannot use the telephone properly because the information normally displayed on the display device necessary for this purpose is not displayed.

### SUMMARY

The function of outputting help text in accordance with the present invention no longer requires the use of the display device of the telephone. The user can read all the information shown in the display in parallel with the help information and use his telephone quite normally. The help text itself is reduced by combining the voice output with an appropriate illuminated button. This makes it easier for the user to understand the operating instructions and also memory space for voice output is saved and the administration of country- or language-versions is simplified.

### DETAILED DESCRIPTION OF THE PRESENT EXAMPLES

The present invention offers the user optoacoustic operating instructions for his mobile telephone. To do this, help topics are stored relative to context in the mobile telephone. In particular, this means a function-specific or situation-dependent collection of help topics or help information. The output of the help information is activated on demand, such as by the press of a button or the input of a suitable voice command.

The help information itself, in accordance with the present invention, consists of verbal information in conjunction with a signaling button. This is a button that is illuminated appropriately and also can flash, as an example. Because buttons on a cell phone are normally illuminated, this exemplary type of signaling button is beneficial. Additionally, the illumination of buttons not involved can be switched off so that the signaling button actuated can be easily recognized. Also, the signaling button can be controlled to provide a brighter illumination than the others, as another example.

The present invention combines voice output for help information with the appropriate illumination of one or more buttons. Calling up help functions leads to a voice output of a help text via a speaker in the telephone, for example. Combined with the voice output, the button or buttons that have to be pressed to achieve the required function can, for example, illuminated individually in turn.

If it is necessary to press and hold a button or to press it several times to achieve a specific function, this can be signaled to the user by a correspondingly long or repeated illumination of this button.

An example of how this help support is used is as follows. A user keys in an SMS, for example, and does not know how to switch off the T9 mode. He presses a help button and a voice then explains “To switch off T9 in the normal input mode press”.

At the same time the relevant button illuminates, such as, for example, the brightness of illumination of the other buttons is reduced. In order to be able to detect which key the help text refers to even in a bright environment, the relevant button can also be controlled so that it is particularly brightly illuminated. It may also flash and/or the other keys could also be switched off briefly. Pressing the help button again could call up other help texts that can be used in this context. A context sensitive sequence of offered help text would make the invention even more attractive to the user.

In the above example, when an SMS is input, an instruction to switch to the normal input mode would not be given when the help button is pressed after detection of a complete word in T9 mode. Instead an explanation would be provided, such as how the SMS can be saved or transmitted.

Similar examples are to be found in the operation of the telephone book of the mobile telephone, when calling up subscriber lists or calling up Internet content. In these situations, the information content of the presently active applications that can be displayed simultaneously as help is important to the user.

It should be understood that various changes and modifications to the presently preferred examples described herein will be apparent to those skilled in the art. Such changes and modifications can be made without departing from the spirit and scope of the present invention and without diminishing its intended advantages. It is therefore intended that such changes and modifications be covered by the appended claims.

1. (canceled)

2. A method for outputting help information on a mobile radio device in which context-related help information for operation and input functions is stored, the method comprising:
receiving a request for help information;
outputting help information with acoustic output and one or more signaling buttons.

3. A method as defined in claim 2, wherein outputting help information by one or more signaling buttons includes one or more of illuminating the signaling buttons at an illumination level different from other buttons, repeated illumination of one or more buttons, switching off illumination of buttons not involving in signaling.

4. A method as defined in claim 2, wherein acoustic output includes voice output of a help text via a speaker in the mobile radio device.
